(19) United States
(12) Patent Application Publication
(10) Pub. No.: US 2015/0081482 A1
(43) Pub. Date: Mar. 19, 2015

(54) ANALYTICS-DRIVEN AUTOMATED RECONCILIATION OF FINANCIAL TRANSACTIONS

(71) Applicant: International Business Machines Corporation, Armonk, NY (US)

(72) Inventors: JoAnn P. Brereton, Hawthorne, NY (US); Arun Hampapur, Norwalk, CT (US); Hongfei Li, Briarcliff Manor, NY (US); Robin Lougee, Yorktown Heights, NY (US); Buyue Qian, Ossining, NY (US)

(73) Assignee: International Business Machines Corporation, Armonk, NY (US)

(21) Appl. No.: 14/155,540

(22) Filed: Jan. 15, 2014

Related U.S. Application Data
(63) Continuation of application No. 14/027,402, filed on Sep. 16, 2013.

(51) Int. Cl. G06Q 40/00

(52) U.S. Cl. CPC G06Q 40/12
USPC 705/30

(57) ABSTRACT

Embodiments relate to analytics-driven automated reconciliation of financial transactions. External information is correlated with a plurality of financial transaction reconciliation exceptions associated with a sequence of financial transactions over a period of time. A plurality of causal factors is identified from the external information associated with a pattern of the financial transaction reconciliation exceptions. A plurality of more recent financial transactions is monitored for the causal factors. An exception prediction alert is issued based on identifying the causal factors in the more recent financial transactions prior to detecting a new financial transaction reconciliation exception associated with the more recent financial transactions.

### CROSS-REFERENCE TO RELATED APPLICATIONS

This is a continuation application that claims the benefit of U.S. patent application Ser. No. 14/027,402 filed Sep. 16, 2013, the contents of which are incorporated by reference herein in their entirety.

### BACKGROUND

The present invention relates to financial transaction management systems and, more specifically, to systems and methods for analytics-driven automated reconciliation of financial transactions.

Financial transactions often involve a period of latency that can span multiple days for the transactions to complete. For example, a transfer of funds between accounts can take two or more days to clear. Backend systems typically attempt to reconcile transactions in batches within a day or two of initiating the transactions. Reconciliation of financial transactions typically involves verifying that charges are accurate and charged to an appropriate account. Inability to reconcile financial transactions may occur, for example, between a bank and an organization where a check or list of checks issued by the organization has not been presented to the bank; a banking transaction such as a credit received or a charge made by the bank has not yet been recorded in the organization's books; or either the bank or the organization itself has made an error.

When existing systems fail to fully reconcile financial transactions, manual cash reconciliation may be performed. However, manual cash reconciliation can be tedious, costly, labor intensive and error-prone. As a result, many organizations fail to perform timely reconciliations and fail to identify possible irregularities that put the organizations at risk.

### SUMMARY

According to one embodiment of the present invention, a method for analytics-driven automated reconciliation of financial transactions is provided. The method includes correlating, by a processor networked to external data sources, external information with a plurality of financial transaction reconciliation exceptions associated with a sequence of financial transactions over a period of time. A plurality of causal factors is identified from the external information associated with a pattern of the financial transaction reconciliation exceptions. A plurality of more recent financial transactions is monitored for the causal factors. An exception prediction alert is issued based on identifying the causal factors in the more recent financial transactions prior to detecting a new financial transaction reconciliation exception associated with the more recent financial transactions.

According to another embodiment of the present invention, a system for analytics-driven automated reconciliation of financial transactions is provided. The system includes a processor communicatively coupled to external data sources via a network; and an exception prediction tool executable by the processor, the exception prediction tool configured to implement a method. The method includes correlating external information with a plurality of financial transaction reconciliation exceptions associated with a sequence of financial transactions over a period of time. A plurality of causal factors is identified from the external information associated with a pattern of the financial transaction reconciliation exceptions. A plurality of more recent financial transactions is monitored for the causal factors. An exception prediction alert is issued based on identifying the causal factors in the more recent financial transactions prior to detecting a new financial transaction reconciliation exception associated with the more recent financial transactions.

According to a further embodiment of the present invention, a computer program product for analytics-driven automated reconciliation of financial transactions is provided. The computer program product includes a storage medium embodied with machine-readable program instructions, which when executed by a computer causes the computer to implement a method. The method includes correlating external information with a plurality of financial transaction reconciliation exceptions associated with a sequence of financial transactions over a period of time. A plurality of causal factors is identified from the external information associated with a pattern of the financial transaction reconciliation exceptions. A plurality of more recent financial transactions is monitored for the causal factors. An exception prediction alert is issued based on identifying the causal factors in the more recent financial transactions prior to detecting a new financial transaction reconciliation exception associated with the more recent financial transactions.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 depicts a block diagram of a system upon which analytics-driven automated reconciliation of financial transactions may be implemented according to an embodiment of the present invention;

FIG. 2 depicts a data flow diagram for analytics-driven automated reconciliation of financial transactions according to an embodiment;

FIG. 3 depicts a data flow diagram for exception prediction according to an embodiment;

FIG. 4 depicts a process for analytics-driven automated reconciliation of financial transactions according to an embodiment; and

FIG. 5 depicts a computer system for analytics-driven automated reconciliation of financial transactions according to an embodiment.

### DETAILED DESCRIPTION

Exemplary embodiments provide analytics-driven automated reconciliation of financial transactions for banking or financial organizations. Embodiments can operate on financial transactions and data from multiple sources to perform analytics-driven automated reconciliation of financial transactions. The financial transactions may be associated with two or more compartmentalized entities, also referred to as “silos”, which can be effectively isolated from each other and observed without direct modification. The financial transactions can define accounts, time windows, amounts, and parties involved. Reconciling financial transactions can include reviewing multiple related transactions over a period of time to ensure timing, accounts, funding, and financial transaction parties are correct as funds are allocated and distributed.

In exemplary embodiments, a sequence of financial transactions is analyzed for violations of one or more reconciliation rules as financial transaction reconciliation exceptions. Analytics may be applied to the financial transaction reconciliation exceptions by correlating external information with bank system data and the financial transaction reconciliation exceptions to form integrated information. Causal analysis is applied on the integrated information to identify causal factors. A plurality of more recent financial transactions is monitored for the causal factors. An exception prediction alert is issued based on identifying the causal factors in the more recent financial transactions prior to detecting a new financial transaction reconciliation exception associated with the more recent financial transactions.

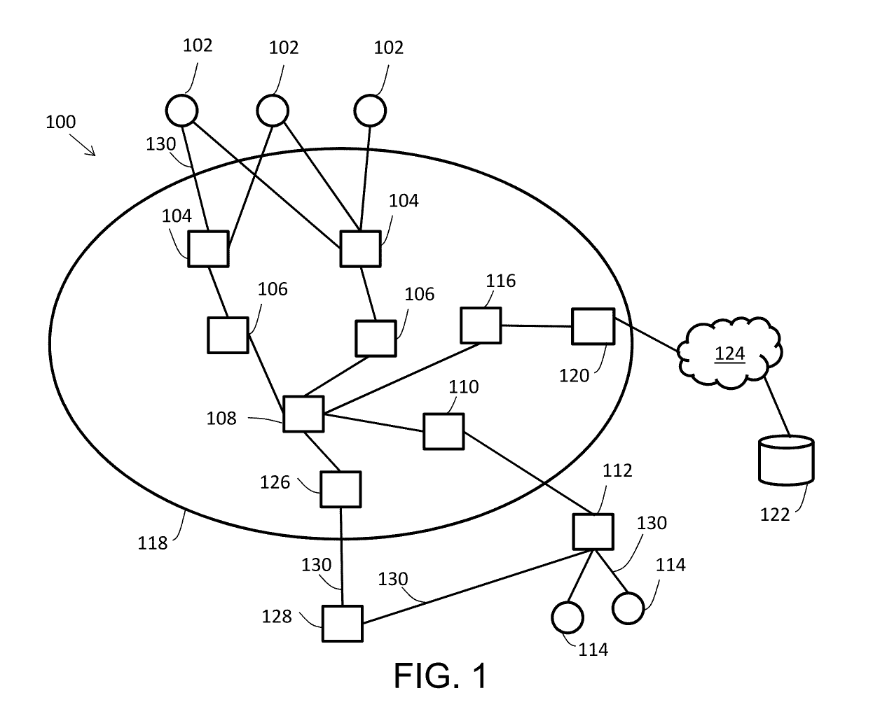

Turning now to FIG. 1, a bank management system 100 upon which analytics-driven automated reconciliation of financial transactions may be implemented will now be described in an exemplary embodiment. Although described in terms of a bank management system 100 in FIG. 1, it will be understood that analytics-driven automated reconciliation of financial transactions can be applied to any system configured to reconcile financial transactions. As depicted in FIG. 1, the bank management system 100 includes a plurality of electronic access points 102 in communication with gateways 104. Each of the gateways 104 may be coupled to a department computer system 106. Each department computer system 106 is coupled to a central banking computer system 108. The central banking computer system 108 may also be accessed via gateway 110 by bank branches 112 that provide physical access to customers 114.

A network 118 enables communication throughout the bank management system 100. The bank management system 100 and network 118 may be geographically distributed in different locations.

An organization 128 may initiate financial transactions 130 through bank branches 112 and/or via gateway 126 through the network 118. The financial transactions 130 can include requests to transfer funds between accounts, including accounts that are external to the bank management system 100. Other financial transactions 130 can also be initiated by the electronic access points 102, the customers 114, and/or internally within the bank management system 100.

Reconciliation of the financial transactions 130 in the bank management system 100 can be performed by a financial transaction reconciliation computer system 120. In the example of FIG. 1, the financial transaction reconciliation computer system 120 is configured to communicate with the central banking computer system 108 via a gateway 116. The financial transaction reconciliation computer system 120 can also access external data sources 122 in real-time through a network 124. The external data sources 122 may include third-party generated data, such as credit reports, new reports, stock market data, bond market data, and the like. The network 124 may be any type of network known in the art. In one example, the network 124 is the Internet.

Although the bank management system 100 is depicted in FIG. 1 including a limited number of elements and connections between elements, the scope of embodiments is not so limited. There may be any number of instances of the electronic access points 102, gateways 104, department computer system 106, central banking computer system 108, gateway 110, bank branches 112, gateway 116, network 118, financial transaction reconciliation computer system 120, gateway 126, and organization 128 with various topologies. Additional elements can be added, removed, or combined. Moreover, the financial transaction reconciliation computer system 120 can be distributed in multiple computer systems and can access other networks and/or data sources (not depicted). In exemplary embodiments, the network 118 provides a generic communication interface between a number of elements that may otherwise be isolated from each other. For example, instances of the department computer system 106 can be separate compartmentalized entities or silos relative to each other.

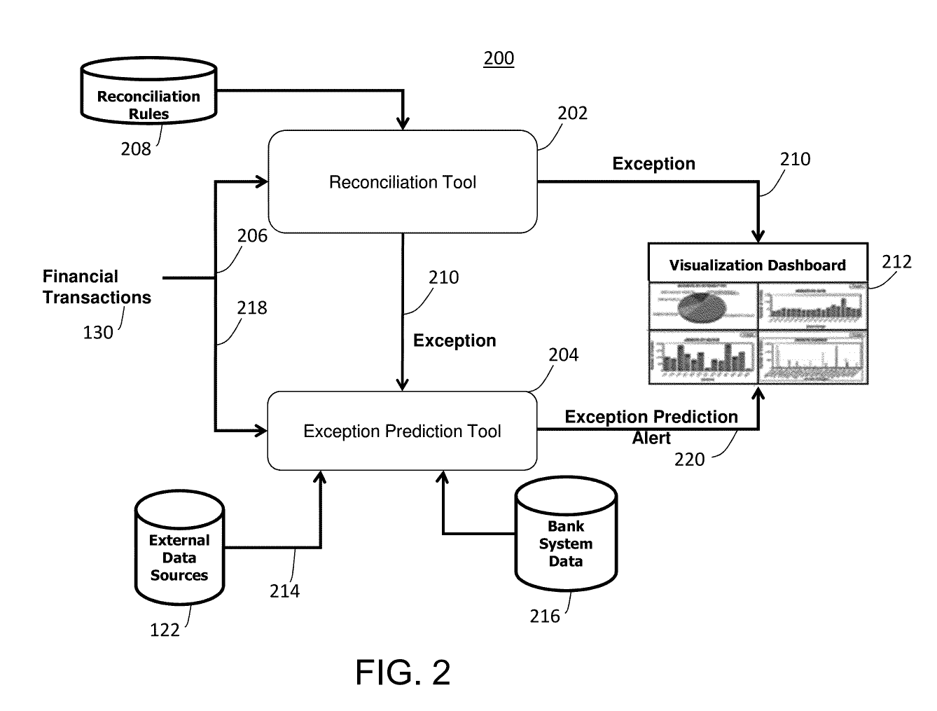

FIG. 2 depicts a high-level data flow diagram 200 for analytics-driven automated reconciliation of financial transactions according to an embodiment. A reconciliation tool 202 and an exception prediction tool 204 may be executed on the financial transaction reconciliation computer system 120 of FIG. 1. The financial transactions 130 of FIG. 1 can be received as a sequence of financial transactions 206 that are analyzed by the reconciliation tool 202. The sequence of financial transactions 206 may include one or more of: a sequence of bank transactions and a sequence of ledger transactions.

The reconciliation tool 202 can access one or more reconciliation rules 208 to determine whether a violation is identified. The reconciliation tool 202 reports a financial transaction reconciliation exception 210 based on a violation. The reconciliation tool 202 can match financial transactions 130 within the sequence of financial transactions 206 to look for discrepancies according to the one or more reconciliation rules 208. A violation of one or more reconciliation rules 208 can include a discrepancy in one or more of: an account, an amount, a time window, and a transaction type. The financial transaction reconciliation exception 210 can be reported to a visualization dashboard 212 for viewing and performing further analysis. The financial transaction reconciliation exception 210 is also provided to the exception prediction tool 204. As multiple instances of financial transaction reconciliation exceptions 210 are generated, the exception prediction tool 204 can extract patterns for exception prediction.

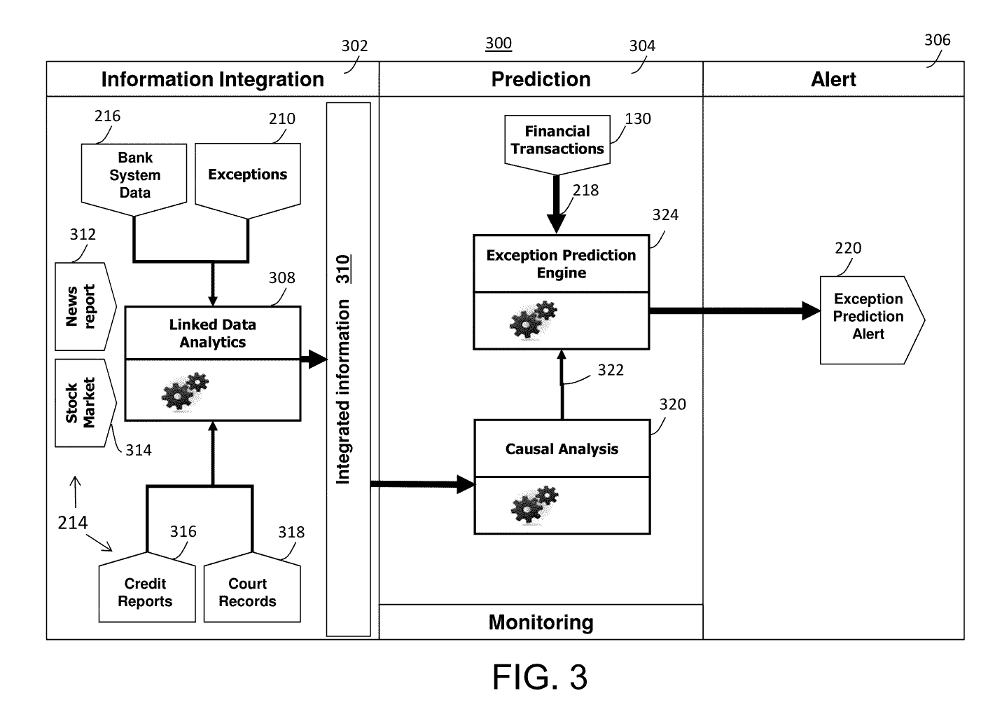

The exception prediction tool 204 correlates external information 214 from the external data sources 122 of FIG. 1 with the financial transaction reconciliation exceptions 210 that are associated with the sequence of financial transactions 206 over a period of time. Correlation of data performed by the exception prediction tool 204 may also include accessing bank system data 216 for customer data, account information, customer payment histories and historical failed transactions, and the like which are already stored in the bank management system 100 of FIG. 1. The exception prediction tool 204 monitors more recent financial transactions 218 in the sequence of financial transactions 206 to generate an exception prediction alert 220 prior to the reconciliation tool 202 detecting a new financial transaction reconciliation exception associated with the more recent financial transactions 218. The exception prediction alert 220 can be output to the visualization dashboard 212. Further details regarding the exception prediction tool 204 are described in reference to FIG. 3.

FIG. 3 depicts a data flow diagram 300 for exception prediction according to an embodiment. The data flow diagram 300 depicts three stages including information integration 302, prediction and monitoring 304, an alert stage 306. The information integration 302 includes linked data analytics 308 that correlates the external information 214 of FIG. 2 with the bank system data 216 of FIG. 1 and a plurality of financial transaction reconciliation exceptions 210 of FIG. 2 to form integrated information 310. The external information 214 can include data from a variety of sources that may indicate risks associated with parties involved in the financial transaction reconciliation exceptions 210. For example, the external information 214 may include data from news reports 312, stock market 314, credit reports 316, and/or court records 318. Other external data sources (not depicted) may also provide the external information 214. The integrated information 310 is provided to causal analysis 320 as part of prediction and monitoring 304.

In an exemplary embodiment, the causal analysis 320 analyzes the integrated information 310 to identify causal factors 322. The causal analysis 320 searches for patterns in the integrated information 310 associated with the financial transaction reconciliation exceptions 210 and other data sources to identify the causal factors 322. The causal factors 322 may include identifying a higher risk condition associated with a financial transaction party and at least one previous financial transaction reconciliation exception 210 associated with the financial transaction party. The causal analysis is used to identify the root causes of transaction reconciliation exceptions or problems that cause operating events. The analysis associates multiple factors with the exception and non-exception transaction records to identify those that have significant impacts on exceptions.

The causal factors 322 are provided to an exception prediction engine 324 to perform predictive analysis. The exception prediction engine 324 monitors the more recent financial transactions 218 of FIG. 2 for the causal factors 322. The exception prediction engine 324 can be developed through various machine learning and statistical techniques. One example uses a Support Vector Machine (SVM) to classify all transactions into exceptions and non-exceptions using customer profile, customer historical transaction patterns, customer exception histories, the information of transaction itself, etc. as inputs. The exception prediction engine 324 issues the exception prediction alert 220 based on identifying the causal factors 322 in the more recent financial transactions 218.

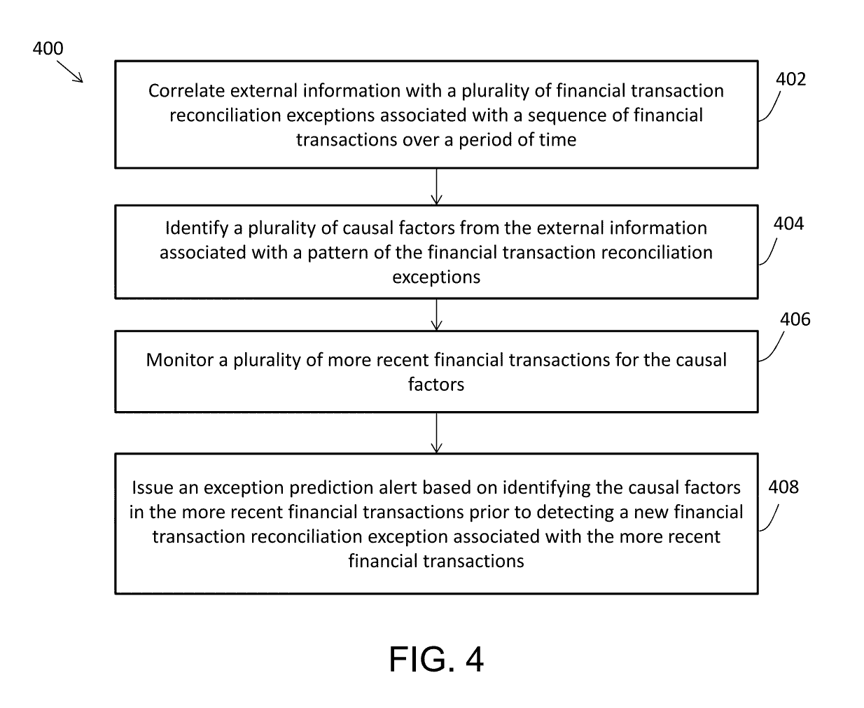

FIG. 4 depicts a process 400 for analytics-driven automated reconciliation of financial transactions in accordance with an embodiment. The process 400 is described in reference to FIGS. 1-4 and need not be performed in the precise order as depicted in FIG. 4. In this example, a processor of the financial transaction reconciliation computer system 120 of FIG. 1 executes the reconciliation tool 202 and exception prediction tool 204 to perform the process 400. Initially, the reconciliation tool 202 may analyze the sequence of financial transactions 206 for a violation of one or more reconciliation rules 208 and report a financial transaction reconciliation exception 210 based on the violation. The violation of one or more reconciliation rules 208 may include a discrepancy in one or more of: an account, an amount, a time window, and a transaction type.

At block 402, the exception prediction tool 204 correlates external information 214 with a plurality of financial transaction reconciliation exceptions 210 associated with a sequence of financial transactions 206 over a period of time. The exception prediction tool 204 may correlate the external information 214 with bank system data 216 and the plurality of financial transaction reconciliation exceptions 210 to form integrated information 310.

At block 404, the exception prediction tool 204 identifies a plurality of causal factors 322 from the external information 214 associated with a pattern of the financial transaction reconciliation exceptions 210. The causal analysis may be applied on the integrated information 310 to identify the causal factors 322 to include, for example, the bank system data 216 as part of the analysis.

At block 406, the exception prediction tool 204 monitors a plurality of more recent financial transactions 218 for the causal factors 322. At block 408, the exception prediction tool 204 issues an exception prediction alert 220 based on identifying the causal factors 322 in the more recent financial transactions 218 prior to the reconciliation tool 202 detecting a new financial transaction reconciliation exception 210 associated with the more recent financial transactions 218.

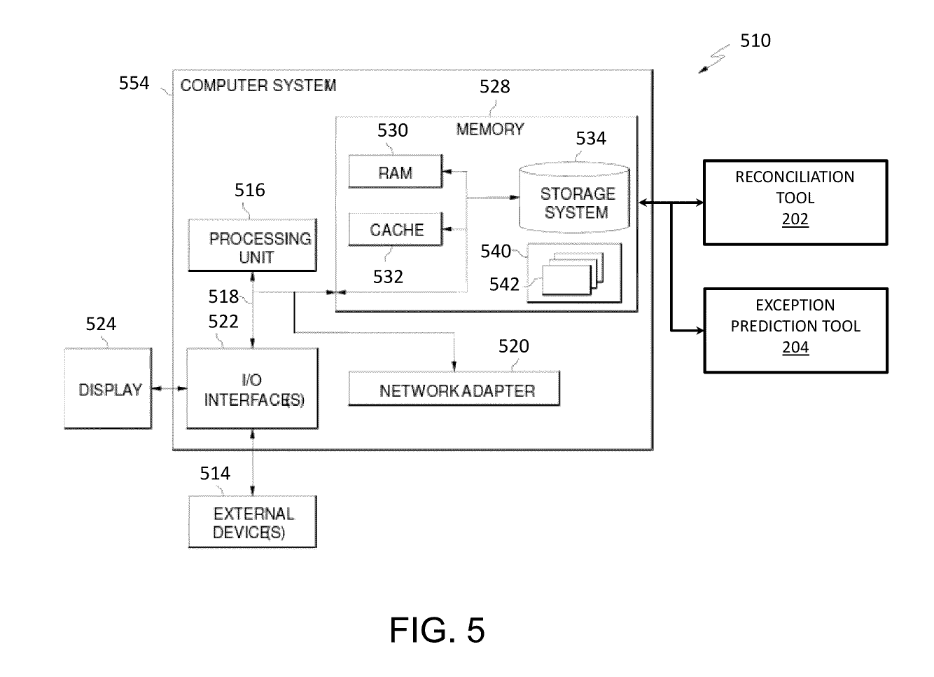

Referring now to FIG. 5, a schematic of an example of a computer system 554 in an environment 510 is shown. The computer system 554 is only one example of a suitable computer system and is not intended to suggest any limitation as to the scope of use or functionality of embodiments described herein. Regardless, computer system 554 is capable of being implemented and/or performing any of the functionality set forth hereinabove. The computer system 554 is an embodiment of the financial transaction reconciliation computer system 120 of FIG. 1.

In the environment 510, the computer system 554 is operational with numerous other general purpose or special purpose computing systems or configurations. Examples of well-known computing systems, environments, and/or configurations that may be suitable as embodiments of the computer system 554 include, but are not limited to, personal computer systems, server computer systems, cellular telephones, thin clients, thick clients, hand-held or laptop devices, multiprocessor systems, microprocessor-based systems, set top boxes, programmable consumer electronics, network personal computer (PCs), minicomputer systems, mainframe computer systems, and distributed cloud computing environments that include any of the above systems or devices, and the like.

Computer system 554 may be described in the general context of computer system-executable instructions, such as program modules, being executed by one or more processors of the computer system 554. Generally, program modules may include routines, programs, objects, components, logic, data structures, and so on that perform particular tasks or implement particular abstract data types. Computer system 554 may be practiced in distributed computing environments, such as cloud computing environments, where tasks are performed by remote processing devices that are linked through a communications network. In a distributed computing environment, program modules may be located in both local and remote computer system storage media including memory storage devices.

As shown in FIG. 5, computer system 554 is shown in the form of a general-purpose computing device. The components of computer system 554 may include, but are not limited to, one or more computer processing circuits (e.g., processors) or processing units 516, a system memory 528, and a bus 518 that couples various system components including system memory 528 to processor 516. When embodied as the financial transaction reconciliation computer system 120 of FIG. 1, the processor 516 is communicatively coupled to the external data sources 122 of FIG. 1 and the bank system data 216 of FIG. 2 via the networks 124 and 118 of FIG. 1.

Bus 518 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system 554 typically includes a variety of computer system readable media. Such media may be any available media that is accessible by computer system 554, and it includes both volatile and non-volatile media, removable and non-removable media.

System memory 528 can include computer system readable media in the form of volatile memory, such as random access memory (RAM) 530 and/or cache memory 532. Computer system 554 may further include other removable/non-removable, volatile/non-volatile computer system storage media. By way of example only, storage system 534 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 518 by one or more data media interfaces. As will be further depicted and described below, memory 528 may include at least one program product having a set (e.g., at least one) of program modules that are configured to carry out the functions of embodiments of the invention.

Program/utility 540, having a set (at least one) of program modules 542, may be stored in memory 528 by way of example, and not limitation, as well as an operating system, one or more application programs, other program modules, and program data. Each of the operating system, one or more application programs, other program modules, and program data or some combination thereof, may include an implementation of a networking environment. Program modules 542 generally carry out the functions and/or methodologies of embodiments of the invention as described herein. An example application program or module is depicted in FIG. 5 as reconciliation tool 202 and exception prediction tool 204 of FIG. 2. Although the reconciliation tool 202 and exception prediction tool 204 are depicted separately, they can be combined and/or incorporated in any application or module. The reconciliation tool 202 and exception prediction tool 204 can be stored directly in the memory 528 or can be accessible by the processor 516 from a location external to the computer system 554.

Computer system 554 may also communicate with one or more external devices 514 such as a keyboard, a pointing device, a display device 524, etc.; one or more devices that enable a user to interact with computer system 554; and/or any devices (e.g., network card, modem, etc.) that enable computer system 554 to communicate with one or more other computing devices. Such communication can occur via input/output (I/O) interfaces 522. Still yet, computer system 554 can communicate with one or more networks such as a local area network (LAN), a general wide area network (WAN), and/or a public network (e.g., the Internet) via network adapter 520. As depicted, network adapter 520 communicates with the other components of computer system 554 via bus 518. It should be understood that although not shown, other hardware and/or software components could be used in conjunction with computer system 554. Examples, include, but are not limited to: microcode, device drivers, redundant processing units, external disk drive arrays, redundant array of independent disk (RAID) systems, tape drives, and data archival storage systems, etc.

It is understood in advance that although this disclosure includes a detailed description on a particular computing environment, implementation of the teachings recited herein are not limited to the depicted computing environment. Rather, embodiments are capable of being implemented in conjunction with any other type of computing environment now known or later developed (e.g., any client-server model, cloud-computing model, etc.).

Technical effects and benefits include information source integration from a variety of sources to detect and predict exception conditions. Pattern identification can be performed dynamically to adapt to new patterns as they appear in the data. Merging data from external network sources provides additional information and context for making predictions based on data within a networked system. Alert generation and data visualization provides multiple outputs to indicate process performance status and predict exceptions as they are occurring rather than waiting for transaction completion. Alerts can be used to stop or intervene in potentially fraudulent or problematic transactions.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A method for analytics-driven automated reconciliation of financial transactions, comprising:
correlating, by a processor networked to external data sources, external information with a plurality of financial transaction reconciliation exceptions associated with a sequence of financial transactions over a period of time;
identifying, by the processor, a plurality of causal factors from the external information associated with a pattern of the financial transaction reconciliation exceptions;
monitoring, by a processor, a plurality of more recent financial transactions for the causal factors; and
issuing, by the processor, an exception prediction alert based on identifying the causal factors in the more recent financial transactions prior to detecting a new financial transaction reconciliation exception associated with the more recent financial transactions.

2. The method of claim 1, further comprising:
correlating the external information with bank system data and the plurality of financial transaction reconciliation exceptions to form integrated information; and
applying causal analysis on the integrated information to identify the causal factors.

3. The method of claim 1, further comprising:
analyzing the sequence of financial transactions for a violation of one or more reconciliation rules; and
reporting a financial transaction reconciliation exception based on the violation.

4. The method of claim 3, wherein the violation of one or more reconciliation rules further comprises a discrepancy in one or more of: an account, an amount, a time window, and a transaction type.

5. The method of claim 1, wherein the causal factors further comprise identifying a higher risk condition associated with a financial transaction party and at least one previous financial transaction reconciliation exception associated with the financial transaction party.

6. The method of claim 1, further comprising:
outputting the exception prediction alert to a visualization dashboard.

7. The method of claim 1, wherein the sequence of financial transactions comprises one or more of: a sequence of bank transactions and a sequence of ledger transactions.
